(19) United States
(12) Patent Application Publication
(10) Pub. No.: US 2017/0047979 A1
(43) Pub. Date: Feb. 16, 2017

(54) BIT RATE DETERMINATION AND PREDICTION

(71) Applicant: HEWLETT PACKARD ENTERPRISE DEVELOPMENT LP, Houston, TX (US)

(72) Inventors: Souvik Sen, Mountain View, CA (US); Jung Gun Lee, Mountain View, CA (US)

(21) Appl. No.: 15/307,675

(22) PCT Filed: Apr. 30, 2014
(86) PCT No.: PCT/US2014/036006

§ 371 Date: Oct. 28, 2016

(51) Int. Cl. H04B 7/06; H04L 12/24; H04L 5/00; H04W 24/08

(52) U.S. Cl. CPC H04B 7/0626; H04W 24/08; H04L 41/147; H04L 5/0053; H04W 84/12

(57) ABSTRACT

In an example, an optimal bit rate to transmit a packet on a communication channel is determined based on channel state information. A channel quality metric is predicted and the optimal bit rate may be modified based on the prediction.

### BACKGROUND

The deployment of wireless local area networks (WLANs) has recently experienced explosive growth as multiple applications and services now demand high throughput networks. A WLAN, such as an IEEE 802.11n system, includes modulation and coding schemes (MCSs) for a transmitter to employ to transmit data to receivers in the network. To transmit the data to a receiver, the transmitter selects one of the MCSs to modulate, encode, and transmit the data over one of the communication channels in the network. Typically, the selection of the MCS is made through a probing process in which communication of data is iteratively attempted at different bit rates until a working bit rate is found.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a WLAN, according to an example of the present disclosure;

FIG. 2 shows a block diagram of a device that may transmit and receive data in the WLAN, according to an example of the present disclosure;

FIG. 3 shows bit error rates for bit rates determined for a moving mobile device in a MAN, according to an example of the present disclosure;

FIG. 4 shows a method for determining whether to modify an optimal bit rate, according to an example of the present disclosure;

FIG. 5 shows a method for determining an optimal bit rate, according to an example of the present disclosure: and

FIG. 6 shows a method for modifying an optimal bit rate, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. In the present disclosure, the term “includes” means includes but not limited thereto, the term “including” means including but not limited thereto. The term “based on” means based at least in part on. In addition, the terms “a” and “an” are intended to denote at least one of a particular element.

According to an example, a bit rate to be implemented by a transmitter for transmitting data packets to a receiver is determined For example, a modulation and coding scheme (MCS) is the matching of the modulation, coding and other signal and protocol parameters to the conditions of a communication channel, such as a radio link for a wireless local area network (WLAN). Different MCS schemes may have different bit rates. The bit rate is the throughput of the channel, which may be measured in terms of megabits per seconds (Mbps). According to an example of the present disclosure, a bit rate and the corresponding MCS scheme may be selected for transmitting a packet based on current communication channel conditions determined from channel state information (CSI) of received packets and based on predictions of future communication channel conditions. For example, an optimal bit rate is selected based on CSI of a communication channel on which packets are received. An optimal bit rate for example is a maximum bit rate to transmit a packet on the communication channel while maintaining transmission quality at a predetermined level. Thus the optimal bit rate may maximize bit rate while maintaining a predetermined transmission quality. A channel quality metric may be used to ascertain the transmission quality. Bit error rate (BER) is one example of a channel quality metric but others may be used. Signal-to-noise ratio (SNR) may also be used as a metric. According to an example which uses BER as a channel quality metric, if the BER of the channel is below 10⁻⁵ for a particular bit rate, it is assumed that bit rate will likely succeed for transmission of a packet on the channel. Based on this assumption, the maximum bit rate at which the calculated BER is less than 10⁻⁵ is the optimal bit rate. The BER may be determined from the CSI of a received packet on the channel in order to determine the optimal bit rate. BER is the number of bit errors divided by the total number of transferred bits during a time interval, and 10⁻⁵ represents the absolute value of the BER.

The optimal bit rate may be based on current channel conditions. For example, the optimal bit rate may be determined from the CSI for at least one of the most recently received packets on the communication channel. However, channel conditions may change prior to transmitting a packet. Accordingly, predictions of the transmission quality are determined, and a new optimal bit rate may be selected based on the predictions prior to transmitting a packet on the communication channel but after initially determining the optimal bit rate based on the CSI of received packets.

The examples of methods and apparatus disclosed herein can maximize the link throughput of a communication channel in a wireless network that is comprised of multiple sub-channels (also referred to as subcarriers). Throughput can be maximized for multi-antenna systems, such as multiple input, multiple output orthogonal frequency-division multiplexing (MIMO-OFDM) systems.

Also, the examples of methods and apparatus disclosed herein can accurately estimate the optimal bit rate for the current wireless link quality with low overhead, and predict the rate for the next packet to be transmitted to modify the optimal bit rate if needed. CSI can be utilized to accurately determine the optimal bit rate and to determine the predictions.

Existing history-based or signal-strength-based rate adaptation schemes cannot capture the channel variations across multiple antenna systems such as IEEE 802.11n and 802.11ac. The examples of methods and apparatus disclosed herein may use CSI reported for every received packet to capture wireless channel quality across multiple antennas. Furthermore, CSI-based rate control is computationally expensive but methods are described herein that allow for CSI-based rate control with low computational overhead. The optimal bit rate can be determined with low overhead, even if there are multiple sub-channels and CSI is determined for each sub-channel as is further described below.

Further, for large inter-packet gaps (such as when there is a significant delay between packet transmissions), rate estimation determined from a previously received packet may not be applicable for future packet transmission. The predictions described herein may be used to modify the optimal bit rate to accommodate varying channel conditions in a wireless environment. For example, if a wireless device is moving while communicating with an access point, the channel conditions may worsen as the wireless device moves away from the access point. The predictions may be used to estimate future link quality degradation and reduce the bit rate or in another example may recognize that bit rate can be increased to maximize throughput.

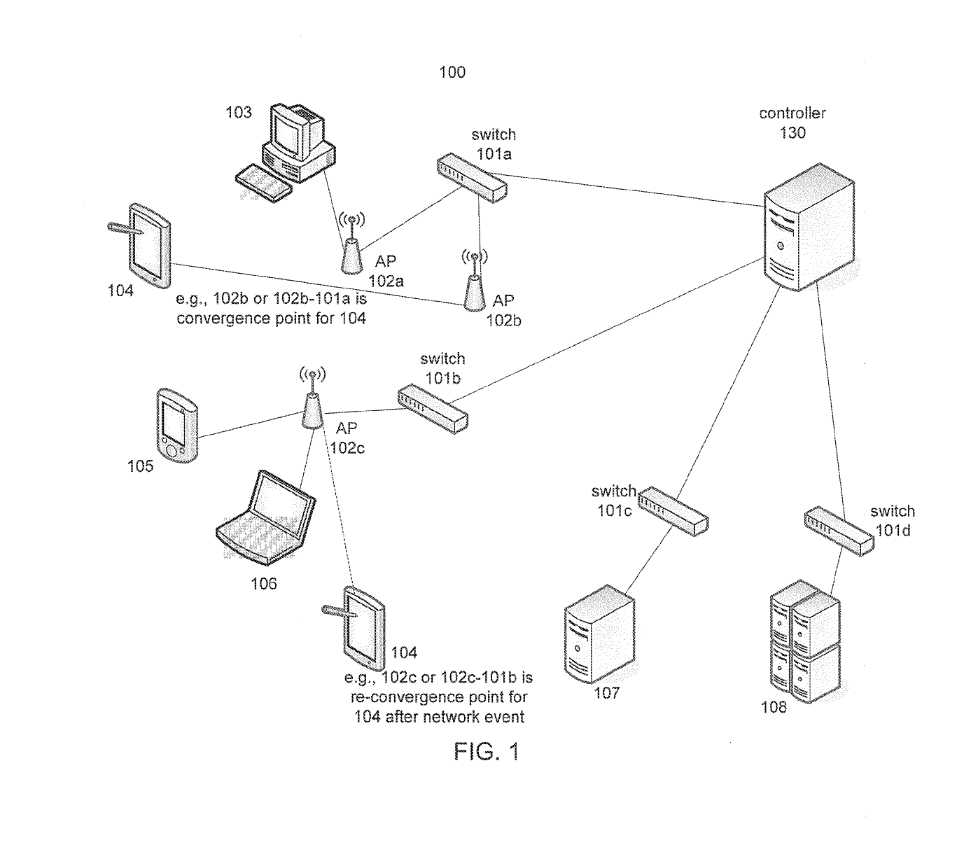

With reference to FIG. 1, there is shown a block diagram of a wireless local area network (WLAN) 100, according to an example of the present disclosure. The WLAN 100 is depicted as including a transmitter 110 and a receiver 120. The transmitter 110 transmits data packets to the receiver 120 via a wireless communication channel 130. According to an example, the transmitter 110 may comprise a wireless access point or a wireless router that operates under any IEEE 802.11x standard, where “x” refers to a current, past or future 802.11 standard, which may include but is not limited to 802.11a/b/g, 802.11n, and 802.11ac. The examples described herein may be applied to other wireless standards as well. The receiver 120 may comprise a communication device, such as a client computer device, server, printer, copier, etc., that can receive data packets from the access point. According to another example, the transmitter 110 of FIG. 1 may comprise the communication device and the receiver 120 may comprise an access point of the WLAN for receiving data packets from the communication device. According to yet another example, the transmitter 110 may comprise a first access point and the receiver 120 may comprise a second access point, which may be in a bridge or mesh network. In these examples, the access point may be connected to a wireless router or may be part of a wireless router, and the wireless router may be connected to an Internet Service Provider to provide Internet access for the communication device or may be connected to another network. It should be understood that the WLAN 100 of FIG. 1 may include additional components, and that the components described herein may be removed and/or modified without departing from a scope of the WLAN 100. For instance, although the WLAN 100 is depicted in FIG. 1 as including two devices, i.e., transmitter 110 and receiver 120, it should be understood that the WLAN 100 may include more than two devices.

In FIG. 1, the transmitter 110 is depicted as including an MCS manager 140 for managing the MCSs implemented by the transmitter 110 in transmitting data packets to destination devices, such as the receiver 120. Selecting the MCS includes selecting the optimal bit rate to transmit packets to the receiver 120 through the communication channel 130. Selecting the optimal bit rate may include determining the optimal bit rate according to current channel conditions and predicting transmission quality to determine whether to modify the bit rate before transmitting a packet to the receiver 120. Determining the optimal bit rate based on current channel conditions may include sampling some or all of the packets received from the receiver 120 on the channel 130, extracting the CSI from each of the sampled data packets, and determining a SNR for each MIMO spatial stream and OFDM subcarrier (e.g., sub-channels) of the MIMO-OFDM communication channel (assuming the channel 130 is a MIMO-OFDM communication channel) at the time each of the sampled data packets was transmitted. The SNR values are used to form a SNR matrix, and the SNR matrix is converted to a bit-error rate (BER) matrix and eventually to an aggregate BER metric, eBER, for each bit rate. The CSI and eBER represent the current conditions and properties of the communication channel over which the data packets were transmitted. To minimize computation complexity, the OFDM sub-channels are grouped, and a sub-channel from the group is selected as a representative of the group and the SNR for the selected sub-channel is used for the entire group. For example, a MIMO system may have 56 subcarriers, which is partitioned into 10 groups, so BERs for 10 subcarriers instead of 56 subcarriers are determined for bit rate determination.

The receiver 120 may include an MCS manager 150. The MCS manager 150 performs the same functions as the MCS manager 140 for example to determine an optimal bit rate to send packets to the transmitter 110 or other destinations. If the receiver 120 is a communications device, such as an end user device (e.g., laptop, mobile handset, etc.), server, etc., but is not an access point or a wireless router, the receiver 120 may not include the MCS manager 150. The receiver 120 may include a conventional 802.11x interface to send and receive packets in a 802.11n WLAN.

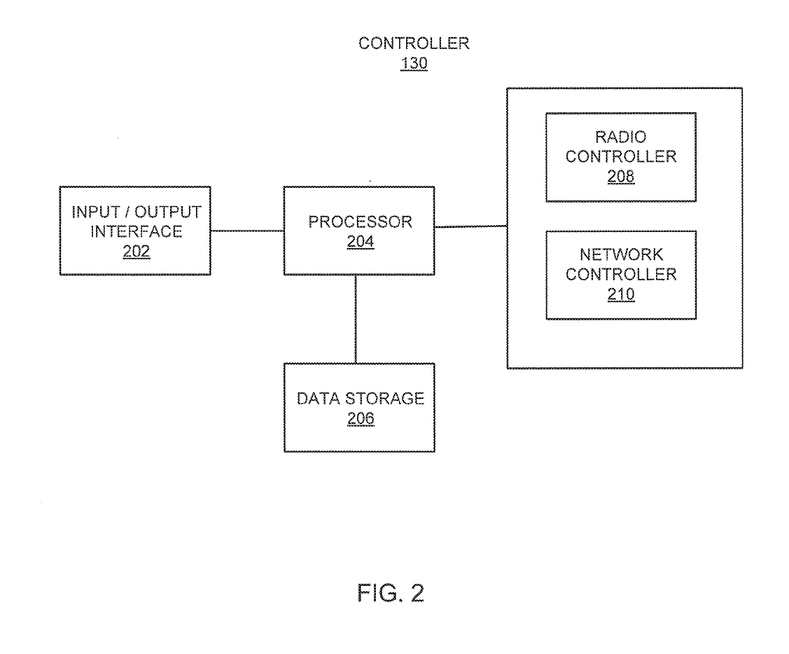

With reference now to FIG. 2, there is shown a block diagram of a transmitter 110, according to an example of the present disclosure. Some or all of the components shown in FIG. 2 may be provided in the receiver 120. It should be understood that the transmitter 110 may include additional components not shown in FIG. 2 and that one or more of the components described herein may be removed and/or modified without departing from a scope of the transmitter 110. Also, the transmitter 110, although referred to as a transmitter, is capable of sending and receiving packets in the WLAN.

The transmitter 110 is depicted in FIG. 2 as including an input/output interface 202, a processor 204, a data storage 206, and the MCS manager 140, which is also depicted in FIG. 1. The processor 204 may include a microprocessor operable to execute machine readable instructions to perform programmed functions and/or hardware dedicated to perform one or more particular functions, such as an application specific integrated circuit (ASIC), field-programmable gate array (FPGA), or other customized integrated circuit.

The MCS manager 140 for example is executed by the processor 204. For example, the modules of the MCS manager 140 may include hardware customized to perform the functions of the modules and/or may include machine readable instructions stored on a non-transitory computer readable medium, such as volatile or non-volatile memory or other type of data storage, and executed by the processor 204 to perform the functions of the modules.

The input/output interface 202 may include a hardware and/or software interface that enables wireless receipt and transmission of data packets. The input/output interface 202 for example includes a WLAN radio interface. The processor 204 may store the data packets received through the input/output interface 202 in the data storage 206 and may use CSI information determined from the data packets to determine the optimal bit rate for future transmission of packets. The data storage 206 may include volatile and/or non-volatile data storage, such as random access memory, memristors, flash memory, and the like. In addition, or alternatively, the data storage 206 comprises a device that is to read from and write to removable data storage media. Machine readable instructions, CSI obtained from packets and any information used by the transmitter 110 may be stored on the data storage 206.

The modules of the MCS manager 140 may include a CSI obtaining module 210, a sub-channel grouping module 212, a bit rate determination module 214 and a transmission quality prediction module 216. The CSI obtaining module 210 receives data packets received by the input/output interface 202 and extracts or reads the CSI from the received data packets through any suitable manner. For instance, in an IEEE 802.11n system, the CSI may be obtained by analyzing the preamble of the received data packets. The CSI values extracted from the received data packets are used to form a CSI matrix for all subcarriers i.e., sub-channels) and MIMO spatial streams in the communication channel.

Generally speaking, the CSI represents the current conditions and properties of the communication channel (e.g., the communication channel 130 shown in FIG. 1) over which the data packets were transmitted. As such, at different points in time, the CSI obtaining module 210 obtains the CSI of the communication channel from the data packets received at the transmitter 110. Receive Signal Strength indicator (RSSI) values are traditionally used to select bit rate but does not perform well for rate selection in a MIMO system. The CSI contains more information about the channel. For example, the CSI captures signal strength and phase information for each OFDM subcarrier and between each pair of transmitter and receiver antennas. An indoor wireless channel is affected by multipath, resulting in different signal strength values on different subcarriers, across different antennas. This can be captured using CSI, however, RSSI, which is essentially an average of these signal strength values, cannot capture this variation. The MCS manager 140 can utilize the CSI to more accurately determine channel conditions and select the optimal bit rate.

The sub-channel grouping module 212 groups sub-channels in the communication channel to determine a channel quality metric, such as BER. Due to the grouping, BER is calculated based on a subset of the CSIs of the sub-channels rather than for all the sub-channels. This reduces computation overhead.

For example, to reduce the computation overhead of CSI-based rate calculations, sub-channels are grouped. A coherence bandwidth of the channel may be used for the groupings. The coherence bandwidth is defined as the bandwidth for which the channel can be considered flat. For example, from the CSI obtained from a first antenna, the coherence bandwidth is determined to approximately be the bandwidth of 10 subcarriers. Thus we can partition the CSI in 6 partitions, i.e., create 6 groups of sub-channels.

If the coherence bandwidth is flat for a group of subcarriers, the SNR of the subcarriers in the group is approximately the same. In one example, SNR of adjacent subcarriers that are similar, such as within a predetermined tolerance of each other (e.g., within 5% variation of each other) are placed in the same group. The 5% variation is one example of a tolerance. Other tolerances may be used to determine the groups.

The bit rate determination module 214 determines the optimal bit rate based on current channel conditions determined from the CSI obtained from packets received on the channel and the BERs of the groups. The optimal bit rate determination based on current channel conditions is described in further detail below.

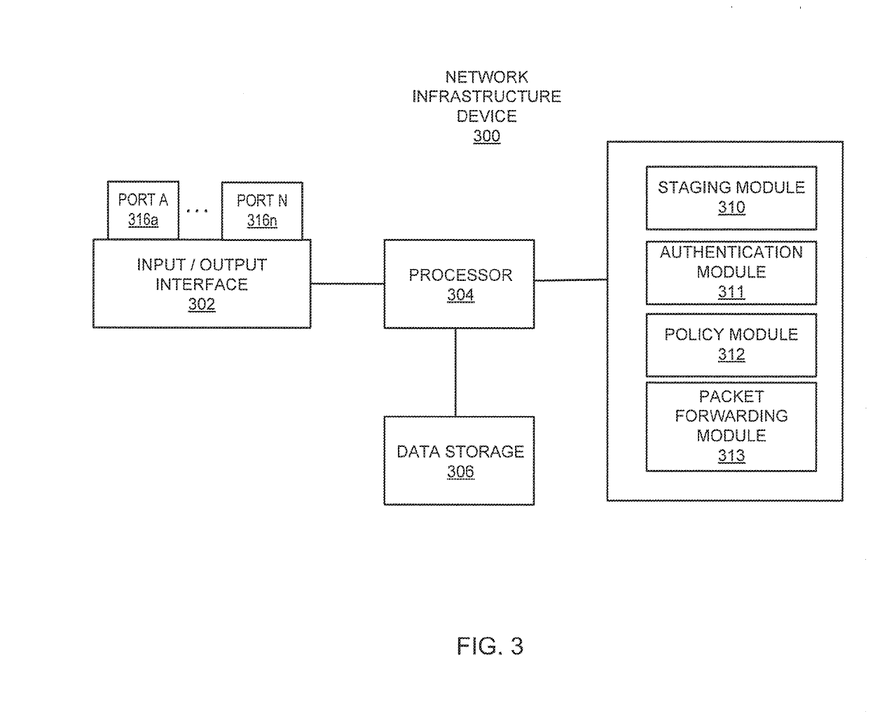

The transmission quality prediction module 216 predicts transmission quality of the channel (e.g., BER) for future packet transmission and may increase or decrease the optimal bit rate determined by the bit rate determination module 214 based on the predictions. Adjusting the optimal bit rate based on the predictions is described with respect to the example in FIG. 3.

As discussed above, only using bit rate estimation may not be sufficient for wireless environments especially when the mobile device communicating with the AP is moving. For example, as a mobile device moves towards or away from an AP, the transmission quality of the channel also changes. As the wireless communication channel changes, the per-rate BER also changes. Predictions are used to account for varying channel quality conditions. Also, BER can be calculated based on SNR but it is noisy. Instead, BER is calculated based on CSI, and CSI is fine-grained enough to allow tracking of channel conditions which may be caused by the mobile device moving towards or away from an AP.

FIG. 3 shows BERs calculated based on CSI for the optimal bit rate, and the next higher bit-rate for 1000 packets in a walking scenario whereby a mobile device is moving away or towards an AP. FIG. 3 shows BER calculated from CSI determined from packets sent and received by an AP in the walking scenario. FIG. 3 also shows when the optimal bit rate changes. At the optimal bit rate, the BER for example is in the range of 10⁻⁵ and 10⁻⁷ inclusive, whereby 10⁻⁵ and 10⁻⁷ are the absolute values of the BER. The y-axis shows log(BER) whereby a BER of 10⁻⁵ is shown as 5, a BER of 10⁻⁷ is shown as 7, and so on for the y-axis values. If the BER increases above 10⁻⁵, then the bit rate should be reduced to try to bring the BER within the range for the optimal bit rate. Similarly, if the BER for the next higher bit rate decreases below 10⁻⁵ or below 10⁻⁷ then the bit-rate can be increased. FIG. 3 shows that the change in BER is almost linear between two different optimal bit rates of 54 Mbps and 36 Mbps. Before an increase of the optimal bit rate, the BER of the next higher rate gradually decreases. Similarly a reduction of the optimal bit rate is preceded by a gradual increase in BER. Since the change in BER tends to be linear, it is possible to extrapolate from the past rate estimates to derive the future BER and hence predict the future bit-rate. According to an example of the present disclosure, the predictions of transmission quality for a bit rate are determined from the rate of change (e.g., slope) of the channel quality metric such as BER. Accordingly, the bit rate is increased or decreased based on history of the BER. For example, if the prediction is that the BER will increase above 10⁻⁵ then the optimal bit rate is reduced to the next lower optimal bit rate, and if the prediction is that the BER will decrease below 10⁻⁵ or 10⁻⁷ then the optimal bit rate is increased to the next higher optimal bit rate. Each bit rate has its own different BER, so the BER is tracked for each optimal bit rate of a set of predetermined optimal bit rates to determine whether the BER will be within the acceptable range if the optimal bit rate is increased or decreased.

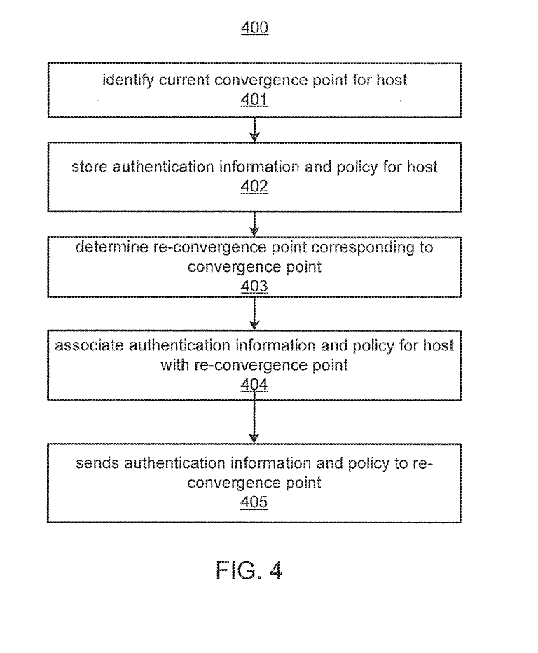

FIGS. 4-6 illustrate examples of methods of the present disclosure. The methods may be performed by the systems shown in FIGS. 1 and 2 or other systems. FIG. 4 shows a method 400 for determining and modifying optimal bit rate for transmission on a communication channel, such as the communication channel 130 shown in FIG. 1. The communication channel may be a wireless communication channel. The communication channel may comprise multiple sub-channels. For example, the communication channel may be in a MIMO-OFDM system that implements an 802.11 protocol, and each channel includes multiple sub-channels (e.g., 56 subcarriers),

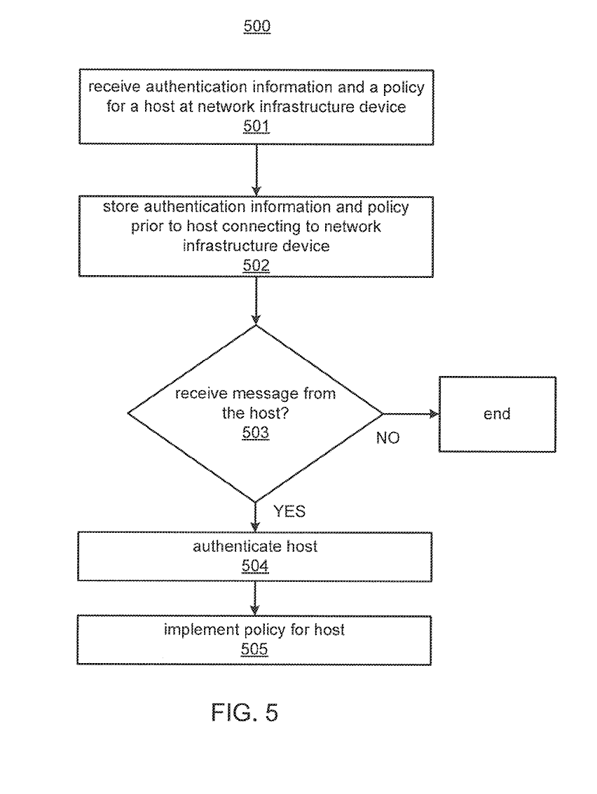

At 401, an optimal bit rate is determined for a communication channel based on the CSI of a packet received on the communication channel. For example, the transmitter 110 shown in FIG. 1 receives a packet or multiple packets from the receiver 120 on the communication channel 130. The CSI obtaining module 210 shown in FIG. 2 obtains the CSI, and the bit rate determination module 214 determines the optimal bit rate based on the CSI of the received packets. Determining the optimal bit rate is further described in the method 500 shown in FIG. 5 and may include grouping sub-channels to minimize computations for bit rate determination.

At 402, a channel quality metric is predicted for the communication channel for example by the transmission quality prediction module 216 shown in FIG. 2. The prediction may be based on the channel quality metric determined for received packets. For example, BERs are determined from the CSI of the received packets. Trends in the BERs are identified, which may include BERs linearly increasing or decreasing, such as shown in FIG. 3. From the trends, a future BER may be estimated for the current optimal bit rate and other optimal bit rates. Predicting the channel quality metric is further described in the method 600 shown in FIG. 6.

At 403, a determination is made as to whether to modify the optimal bit rate to transmit a packet on the communication channel to a receiver based on the prediction. For example, the bit rate determination module 214 shown in FIG. 2 may get the predicted BER for the optimal bit rate determine at 401 and determine whether the predicted BER is acceptable. For example, a BER (e.g., log(BER)=10⁻⁵) or range of BERs (e.g., 10⁻⁵ to 10⁻⁷) is predetermined as acceptable. If the predicted BER exceeds the acceptable BER (i.e., the BER is worse than the acceptable BER), then the optimal bit rate may be lowered, or if the predicted BER falls below the acceptable BER (i.e., the BER is better than the acceptable BER), then the optimal bit rate may be increased.

FIG. 5 shows the method 500 for determining the optimal bit rate based on CSI of received packets. For example, the optimal bit rate is determined based on the current conditions of the channel as measured by the CSI of the received packets. Accordingly, the current conditions may be the conditions at the time the packets are received on the channel. The channel may include multiple sub-channels (i.e., subcarriers).

At 501, the CSI is obtained for the received packets. The CSI may be determined from information in the packet headers.

At 502, the sub-channels are partitioned into groups based on a link quality metric determined for each sub-channel. For example, the coherence bandwidth of a communications channel is defined as the bandwidth for which the channel can be considered flat. For example, the CSI was observed for packets transmitted by an antenna for 56 subcarriers (i.e., sub-channels). A link quality metric, such as SNR is determined for all the subcarriers. Subcarriers having SNRs within a predetermined tolerance of each other are placed in the same group. For example, the 56 subcarriers are partitioned into six groups.

At 503, the CSI is determined for each group. For example, one of the sub-channels is selected for each group and the CSI for the selected sub-channel is the CSI determined for each group.

At 504, a channel quality metric (e.g., BER) is determined for each of a plurality of bit rates for each group based on the CSI for each group. For example, a predetermined set of bit rates may be used on a sub-channel. BER may be determined for each bit rate for each group from the CSI determined for each group.

For example, an SNR is determined from a CSI matrix determined from the CSI values obtained at 501. The CSI values extracted from the received data packets are used to form a CSI matrix for all subcarriers and MIMO spatial streams in the communication channel. CSI-to-SNR conversion is performed to determine the SNR values from the CSI values. CSI-to-SNR conversion processes for example are described in “Performance Analysis of Link Adaptation in LTE Systems” by Tao et al., International ITG Workshop on Smart Antennas (WSA) 2011, and “Predictable 802.11 Packet Delivery from Wireless Channel Measurements” by Halperin et al., ACM SIGCOMM Aug. 30-Sep. 3, 2010 (hereinafter “Halperin”) Generally speaking, each of the SNR values represents the link quality of the communication channel at the time the respective data packet was transmitted. The SNR values of the communication channel may be determined from the CSI values that were obtained for different points in time, and may generate the SNR matrix from the computed SNR values. A BER matrix is computed based upon the SNR matrix calculated. For example, BER values are determined from the SNR values.

At 505, an aggregate channel quality metric for each of the plurality bit rates is determined across the groups. For example, for each bit rate, an aggregate BER is determined from the BERs for the groups for that bit rate.

According to an example, the communication channel comprises an OFDM-MIMO system channel and the plurality of sub-channels comprise sub-channels of the OFDM-MIMO system. A plurality of data spatial streams is transmitted over the plurality of sub-channels. In this example, each aggregate BER value may be calculated using BER values determined from the SNR values. The aggregate BER (i.e., eBER) may be calculated from the BER values according to the following equation:

eBER=Σ^{SS}ᵢΣ^{SC}ⱼBER(SNR_{i,j}), Equation (1)

where, SS represents the total number of data spatial streams transmitted from the transmitter, SC represents the total number of sub-channels of the communication channel, and BER(SNR)_{i,j} represents a BER value of i^{th} data stream in j^{th} group. A time-averaged eBER value may be determined for each transmitter and each bit rate that the transmitter uses for packet transmission. By way of example, if the transmitter-receiver communication channel supports a total of 12 different bit rates, a total of 12 eBER values are calculated.

At 506, the optimal bit rate is selected based on the aggregate channel quality metrics. For example, a maximum bit rate is selected from a set of predetermined bit rates that may be used for transmitting packets in the communication channel that has an aggregated BER (e.g., eBER) that is acceptable, such as in the range of 10⁻⁵ and 10⁻⁷ inclusive or better than 10⁻⁵.

FIG. 6 shows a method 600 for predicting a channel quality metric and determining whether to modify the optimal bit rate for a transmission based on the prediction.

At 601, a rate of change of the channel quality metric is determined for the optimal bit rate, such as the optimal bit rate determined at 401 in the method 400 and at 506 in the method 500. For example, the change in the BER over time may be substantially linear as shown in FIG. 3 and the slope of the BER is determined to extrapolate the BER. The channel quality metric may be BER or the aggregated BER.

At 602, a prediction of the channel quality metric is determined from the rate of change determined at 601 for the optimal bit rate. For example, from the extrapolated BER determined from the slope, a BER is determined for a next time period at which a packet may be transmitted on the channel.

At 603, a determination is made as to whether the predicted channel quality metric at the optimal bit rate is acceptable, such as outside a predetermined range. For example, the BER or eBER is acceptable if it is in the range of 10⁻⁵ and 10⁻⁷ or is less than 10⁻⁵. If the BER is outside the range at the optimal bit rate, the bit rate may be increased or decreased,

At 604, if the predicted channel quality at the optimal bit rate is outside the predetermined range, then the optimal bit rate is modified. For example, a next higher or next lower bit rate in the set of bit rates may be used. For example, if the BER is too high, e.g., above 10⁻⁵, then the next lower bit rate is selected; otherwise the next higher bit rate is selected if the BER is too low. The BER of the next higher or next lower bit rate may be determined for example to determine whether it is in the acceptable range of 10⁻⁵ and 10⁻⁷. If it is not, then another bit rate may be used. If the predicted channel quality metric for the optimal bit rate, which is determined at 602, is acceptable, the optimal bit rate is used to transmit the next packet on the channel at 605.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims, and their equivalents, in which all terms are meant in their broadest reasonable sense unless otherwise indicated.

What is claimed is:

1. A device to send or receive packets on a communication channel, the device comprising;
a data storage to store channel state information (CSI) from packets transmitted on the communication channel; and
a processor to
determine, from the CSI for the packets, an optimal bit rate for the communication channel;
predict a channel quality metric for future transmission on the communication channel at the optimal bit rate based on the channel quality metric determined for the packets; and
determine whether to modify the optimal bit rate to transmit a packet on the communication channel to a receiver based on the prediction.

2. The device of claim 1, wherein the communication channel includes a plurality of sub-channels k whereby k>1, and to determine the optimal bit rate to transmit the packet, the processor is to:
determine a link quality metric for each sub-channel;
partition the sub-channels into groups based on the determined link quality metrics, wherein the number of groups is less than k;
determine a CSI for each group;
determine the channel quality metric for each of a plurality of bit rates for each group based on the CSI for each group;
determine an aggregate channel quality metric for each of the plurality bit rates across the groups from the channel quality metrics determined for each bit rate across the groups; and
select the optimal bit rate based on the aggregate channel quality metrics for each of the plurality bit rates.

3. The device of claim 1, wherein to predict the channel quality metric the processor is to determine a rate of change of the channel quality metric at the optimal bit rate and predict the channel quality metric based on the rate of change, and to determine whether to modify the optimal bit rate, the processor is to compare the predicted channel quality metric to a range of acceptable channel quality metric values, and increase or decrease the optimal bit rate if the predicted channel quality metric is outside the range of acceptable channel quality metric values.

4. The device of claim 3, wherein the channel quality metric is bit error rate (BER) and the processor is to:
decrease the optimal bit rate if the BER is above the range; or
increase the optimal bit rate if the BER is below the range.

5. A device to communicate over a communication channel in a wireless network at different bit rates, wherein the communication channel is divided into a plurality of sub-channels, the device comprising:
a wireless network interface to send or receive packets over the communication channel at different rates; and
a processor to
partition the sub-channels into groups, wherein sub-channels having a link quality metric within a predetermined tolerance are placed in the same groups;
determine channel state information (CSI) for each group according to CSI for a sub-channel in each group;
determine an optimal bit rate for the communication channel based on the CSI for each group;
predict a channel quality metric for future transmission on the communication channel at the optimal bit rate based on the channel quality metric determined for the packets; and
determine whether to modify the optimal bit rate to transmit a packet on the communication channel to a receiver based on the prediction.

6. The device of claim 5, wherein to determine the optimal bit rate, the processor is to:
determine the channel quality metric for each of a plurality of bit rates for each group based on the CSI for each group;
determine an aggregate channel quality metric for each of the plurality bit rates across the groups from the channel quality metrics determined for each bit rate; and
select the optimal bit rate based on the aggregate channel quality metrics for each of the plurality bit rates.

7. The device of claim 5, wherein to determine whether to modify the optimal bit rate, the processor is to:
determine a rate of change of the channel quality metric, wherein the predicted channel quality metric is determined from the rate of change;
compare the predicted channel quality metric to a range of acceptable channel quality metric values; and
increase or decrease the optimal bit rate if the predicted channel quality metric is outside the range of acceptable channel quality metric values.

8. The device of claim 7, wherein the channel quality metric is bit error rate (BER) and the processor is to:
decrease the optimal bit rate if the BER is above the range; or
increase the optimal bit rate if the BER is below the range.

9. A method comprising:
determining groups of subcarriers in a communication channel, wherein the subcarriers in each group have signal to noise ratios (SNR) that are approximately the same;
selecting a subcarrier from each group;
determining a CSI for each selected subcarrier;
determining an optimal bit rate to transmit a packet on the communication channel to a receiver based on the CSI for each subcarrier;
predicting, by a processor, a channel quality metric for future transmission on the communication channel at the optimal bit rate based on the channel quality metric determined for previously received packets; and
determining whether to modify the optimal bit rate to transmit a packet on the communication channel to the receiver based on the prediction.

10. The method of claim 9, wherein determining whether to modify the optimal bit rate comprises:
determining a rate of change of the channel quality metric, wherein the predicted channel quality metric is determined from the rate of change;
comparing the predicted channel quality metric to a range of acceptable channel quality metric values; and
increasing or decreasing the optimal bit rate if the predicted channel quality metric is outside the range of acceptable channel quality metric values.

11. The method of claim 10, wherein increasing or decreasing the optimal bit rate comprises:
decreasing the optimal bit rate if the comparison to the threshold indicates that the channel quality metric is trending towards an unsatisfactory value or increasing the optimal bit rate if the comparison to the threshold indicates that the channel quality metric is not trending towards the unsatisfactory value and the optimal bit rate is operable to be increased.

12. The method of claim 9, wherein determining the optimal bit rate to transmit the packet comprises:
determining the channel quality metric for each of a plurality of bit rates for the selected subcarrier for each group;
determining an aggregate channel quality metric for each of the plurality bit rates across the groups from the channel quality metrics determined for each bit rate; and
selecting the optimal bit rate based on the aggregate channel quality metrics for h of the plurality bit rates.

13. The method of claim 12, wherein the aggregate channel quality metric is an aggregate bit error rate.

14. The method of claim 9, wherein the subcarriers in each group have SNRs within 5% of each other.

15. The method of claim 9, wherein the communication channel comprises an orthogonal frequency-division multiplexing multiple-input-multiple-output (OFDM-MIMO) system channel and the plurality of sub-channels comprise sub-channels of the OFDM-MIMO system.
